(19) United States
(12) Patent Application Publication
(10) Pub. No.: US 2008/0289194 A1
(43) Pub. Date: Nov. 27, 2008

(54) TRIMMER SKIRT

(75) Inventors: David J. Merten, Manitowoc, WI (US); Jay Z. Muchin, Manitowoc, WI (US)

Correspondence Address: RATHE PATENT & IP LAW, 10611 W. HAWTHORNE FARMS LANE, MEQUON, WI, 53097, US

(73) Assignee: M Group, Inc., Manitowoc, WI (US)

(21) Appl. No.: 12/126,140

(22) Filed: May 23, 2008

Related U.S. Application Data
(60) Provisional application No. 60/940,045, filed on May 24, 2007.

(51) Int. Cl. B26B 29/00

(52) U.S. Cl. 30/286

(57) ABSTRACT

A shield is provided for a cutting member of a grass trimmer.

### CROSS-REFERENCE TO RELATED PATENT APPLICATIONS

The present application claims priority under 35 USC 119(e) U.S. Provisional Patent Application Ser. No. 60/940,045 filed on May 25, 2007 by David J. Merten and Jay Z. Muchin and entitled TRIMMER SKIRT, with full disclosure of which is hereby incorporated by reference.

### BACKGROUND

Grass trimming is a messy job. The trimmer head with its minimal guard, throws grass, rocks and debris all over—especially back towards the user.

### BRIEF DESCRIPTION OF THE DRAWINGS

FIG. 1 is a perspective view of a skirt system mounted on a grass trimmer according to an example embodiment.

FIG. 2 is a fragmentary sectional view of the skirt system and grass trimmer of FIG. 1 according to an example embodiment.

FIG. 3 is an enlarged fragmentary perspective view of the skirt system and grass trimmer of FIG. 1 according to an example embodiment.

FIG. 4 is a perspective view of another embodiment of the skirt system of FIG. 1 mounted on the grass trimmer according to an example embodiment.

FIG. 5 is a fragmentary perspective view of another embodiment of the skirt system of FIG. 1 mounted on the grass trimmer according to an example embodiment.

FIG. 6 is a fragmentary sectional view of the skirt system and grass trimmer of FIG. 5 according to an example embodiment

FIG. 7 is a fragmentary perspective view of another embodiment of the skirt system of FIG. 5 mounted on the grass trimmer according to an example embodiment.

FIG. 8 is a fragmentary perspective view of another embodiment of the skirt system of FIG. 1 mounted on the grass trimmer according to example embodiment.

FIG. 9 is a fragmentary sectional view of the skirt system and grass trimmer of FIG. 8 according to an example embodiment.

FIG. 10 is a perspective view of a clip of the skirt system of FIG. 8 according to an example embodiment.

FIG. 11 is a fragmentary perspective view of another embodiment of the skirt system of FIG. 1 mounted on the grass trimmer according to an example embodiment.

FIG. 12 is a fragmentary sectional view of the skirt system and grass trimmer of FIG. 11 according to an example embodiment.

FIG. 13 is a fragmentary perspective view of another embodiment of the skirt system of FIG. 1 mounted on the grass trimmer according to an example embodiment.

FIG. 14 is a front elevational view of the skirt system and grass trimmer of FIG. 13 according to an example embodiment.

FIG. 15 is a sectional view of the skirt system of FIG. 13 according to example embodiment.

FIG. 16 is a fragmentary perspective view of another embodiment of the skirt system of FIG. 1 mounted on the grass trimmer according to an example embodiment.

FIG. 17 is a fragmentary front elevational view of the skirt system and grass trimmer of FIG. 16 according to an example embodiment.

FIG. 18 is a fragmentary perspective view of the skirt system of FIG. 16 according to an example embodiment.

FIG. 19 is a sectional view of the skirt system and grass trimmer of FIG. 16 according to an example embodiment.

FIG. 20 is a fragmentary perspective view of another embodiment of the skirt system of FIG. 1 mounted on the grass trimmer according to an example embodiment.

FIG. 21 is a fragmentary front elevational view of the skirt system and grass trimmer of FIG. 20 according to an example embodiment.

FIG. 22 is a fragmentary sectional view of the skirt system and grass trimmer of FIG. 20 according to an example embodiment.

FIG. 23 is a fragmentary perspective view of another embodiment of the skirt system of FIG. 1 mounted on the grass trimmer according to an example embodiment.

FIG. 24 is a fragmentary front elevational view of the skirt system and grass trimmer according to an example embodiment.

FIG. 25 is an exploded fragmentary sectional view of the skirt and grass trimmer of FIG. 23 according to an example embodiment.

FIG. 26 is a fragmentary sectional view of the skirt system and grass trimmer of FIG. 23 according to an example embodiment.

FIG. 27 is a fragmentary perspective view of another embodiment of the skirt system of FIG. 1 mounted on the grass trimmer according to an example embodiment.

FIG. 28 is a fragmentary front elevational view of the skirt system and grass tremor of FIG. 27 according to example embodiment.

FIG. 29 is a fragmentary sectional view of the skirt system and grass trimmer of FIG. 27 according to an example embodiment.

FIG. 30 is a perspective view of another embodiment of the skirt system of FIG. 1 mounted to a guard of a grass trimmer according to an example embodiment.

FIG. 31 is an exploded perspective view of the skirt system and guard of FIG. 30 according to an example embodiment.

FIG. 32 is a sectional view of the skirt system and guard of FIG. 30 according to example embodiment.

FIG. 33 is a perspective view of a mounting mechanism of the skirt system of FIG. 30 according to an example embodiment.

### DETAILED DESCRIPTION OF THE EXAMPLE EMBODIMENTS

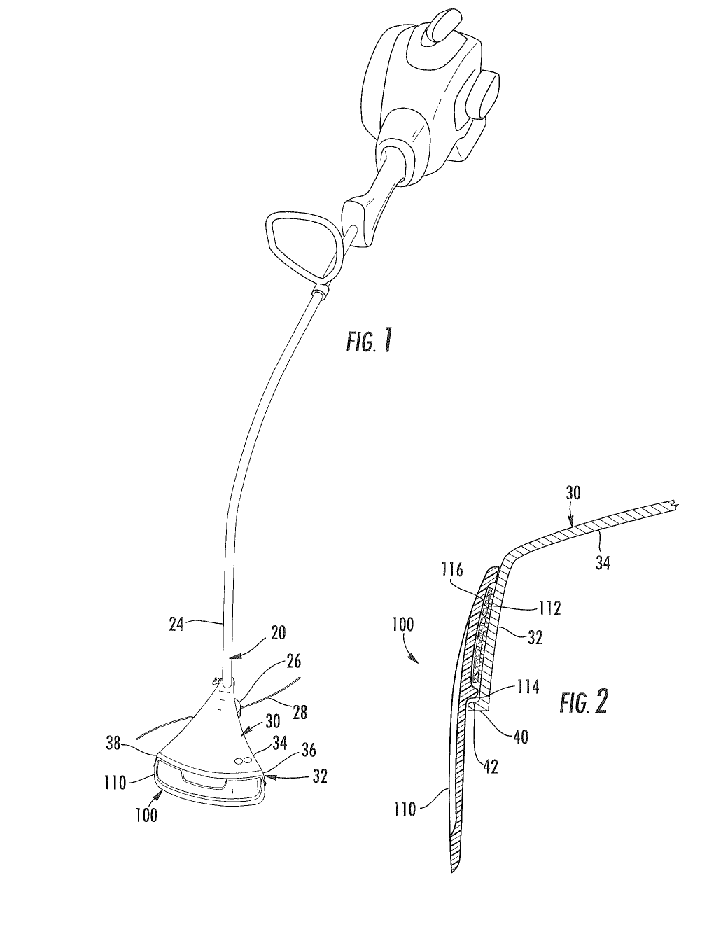

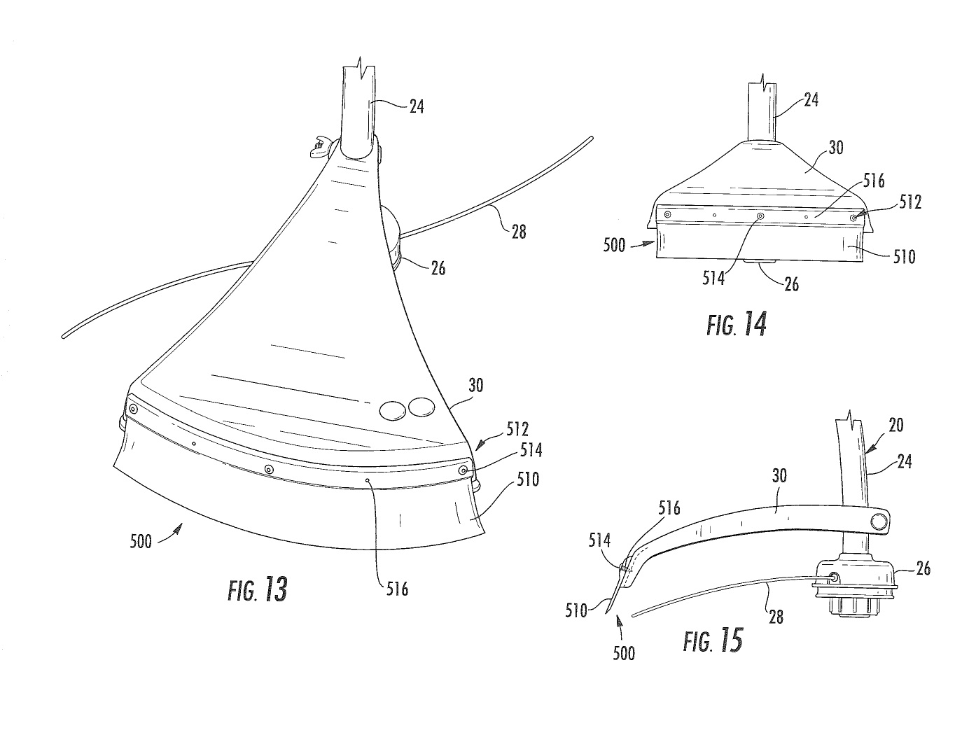

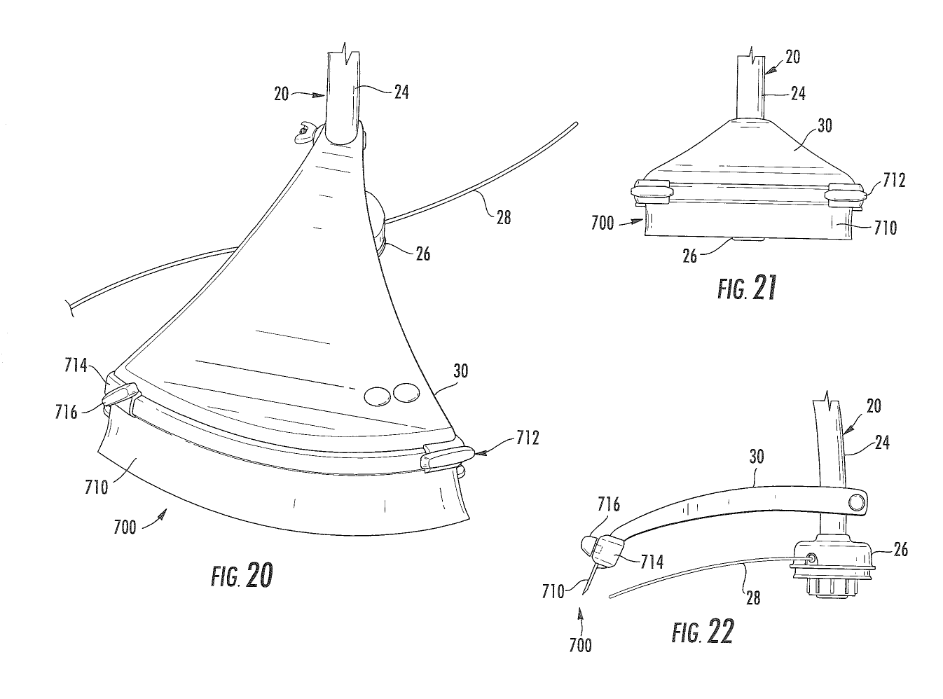

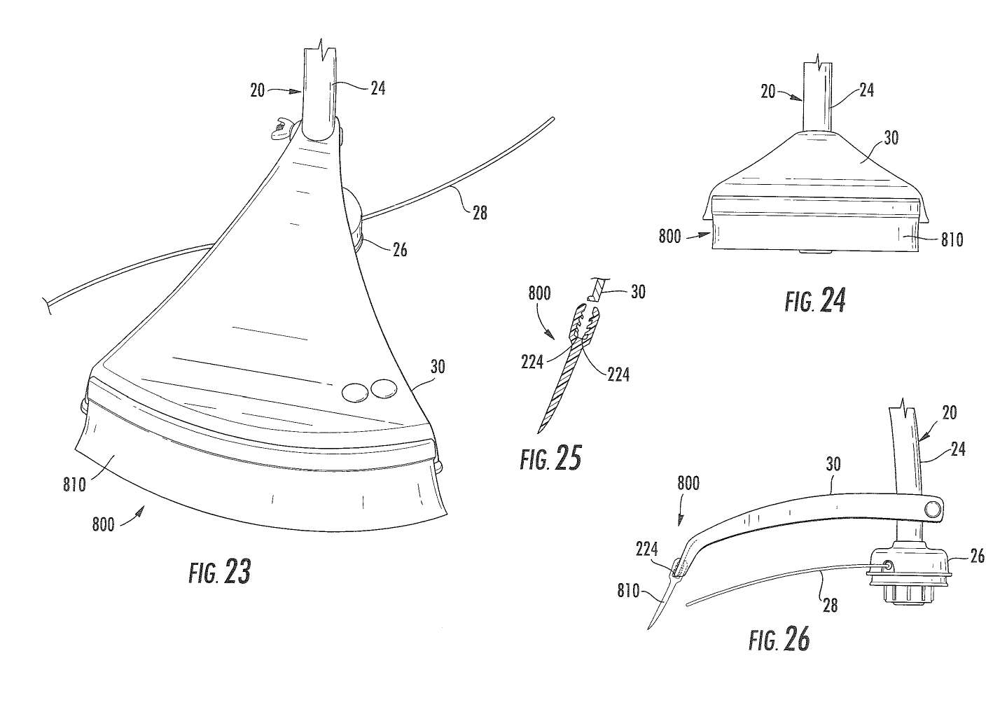

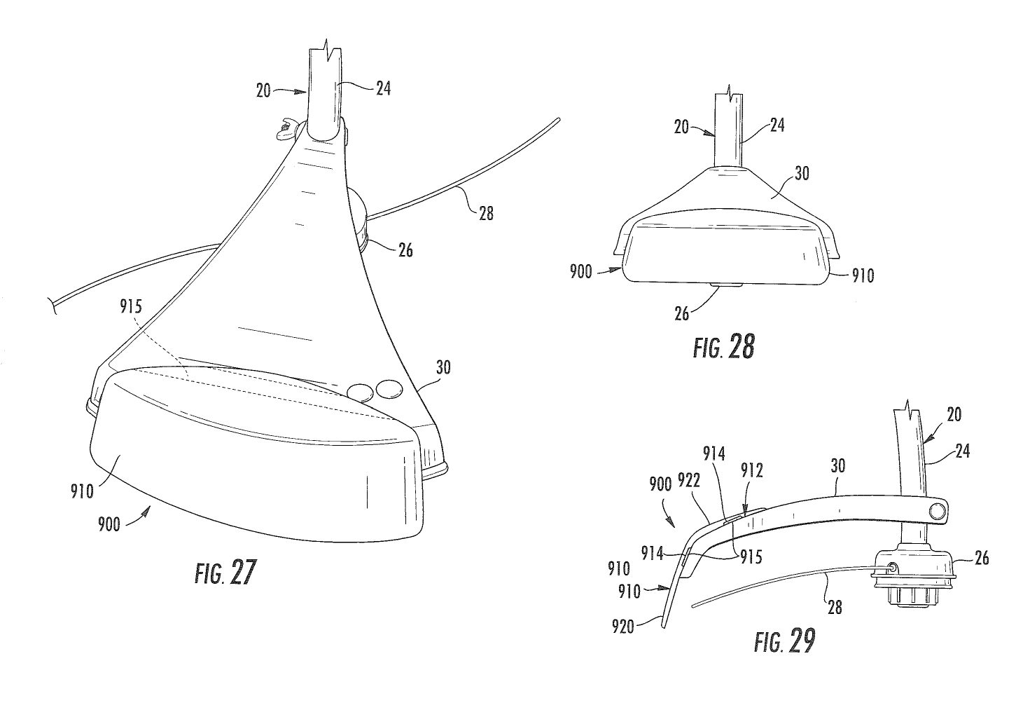

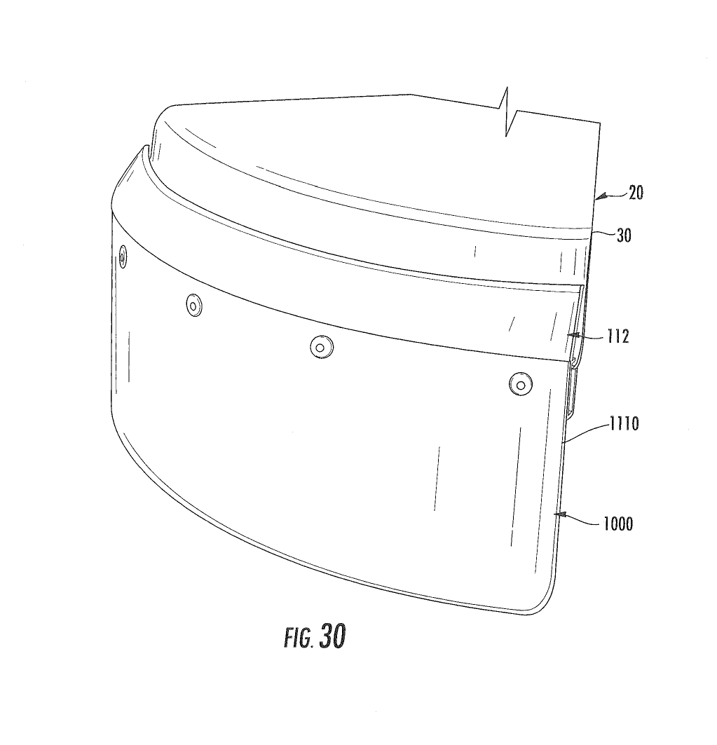

FIGS. 1-33 illustrate various grass trimming systems. Each system includes a grass trimmer 20 and one of a variety of embodiments of skirt systems as described herein. For purposes of this disclosure, the term “grass trimmer” means any electric, cordless or gas powered grass trimmer having a rotating grass cutting member such as a blade, cable, spring and the like. FIG. 1 illustrates an example grass trimmer 20 having a main shaft 24, hub 26, a cutting member 28 and a guard 30. Shaft 24 extends down from a one or more handles, a power supply (electric, electrical outlet or battery supplied, or gas) and controls (not shown). Shaft 24 supports hub 26, cutting member 28 and guard 30. Shaft 24 further encloses power and control transmitting portions of trimmer 20.

Hub 26 is rotationally supported by shaft 20 and carries cutting member 28. Cutting member 28 is configured to be rotated at rapid speeds so as to cut grass and other plant growth. In the example illustrated, cutting member 28 comprises a consumable flexible string or cable. In other embodiments, cutting member 28 may have other configurations.

Guard 30 comprises a structure supported by shaft 20 configured to extend outwardly from shaft 22 define a cutting radius of cutting member 28. Guard 30 includes a side wall 32 and a top 34. Side wall 32 projects downwardly from top 34 at a draft or angle with respect to vertical. Side wall 32 has side edges 36, 38 and a bottom or lower edge 40. In the example illustrated, side wall 36 further includes a step or shoulder 42 proximate to its lower edge 40. Although sidewall 32 is illustrated as being curved or arcuate, in other embodiments, sidewall 32 may have planar or straight segments.

According to one embodiment, sidewall 32 of guard 30 has a wall thickness ranging from between about 0.14 inches to about 0.11 inches. Side wall 32, sometimes referred to as an outboard flange, as a draft ranging from 3 degrees to 6 degrees with respect to vertical. Side wall 32 has an arc length of about 16 inches when trimmer 20 is electrically powered and an arc length of about 7 inches when trimmer 20 is gas powered. Guard 30 has a leading-edge wall thickness of between about 0.24 inches and 0.21 inches. In other embodiments, trimmer 20 and guard 30 may have other configurations and dimensions.

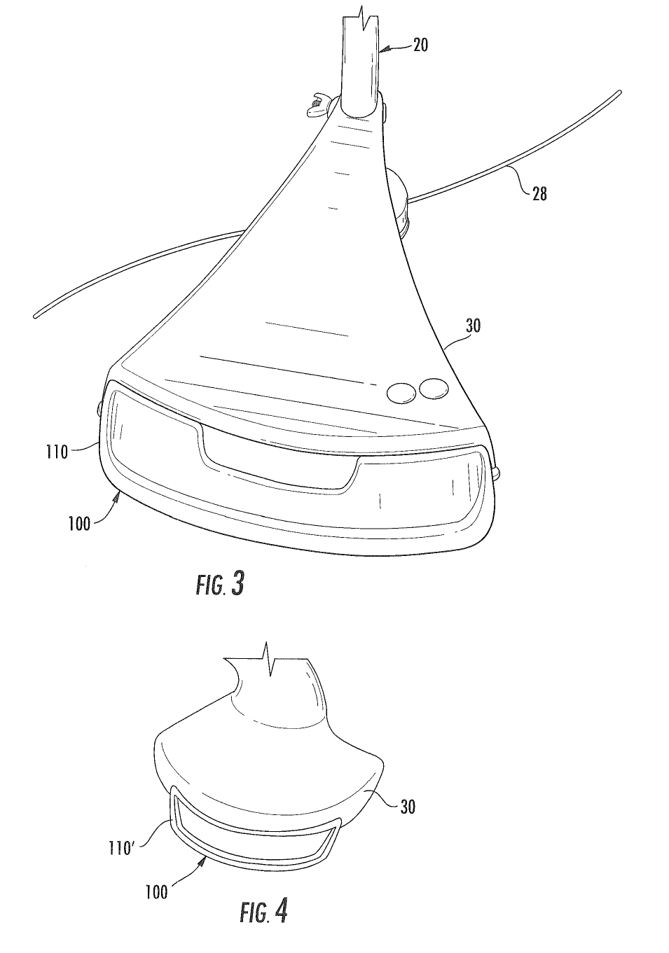

FIGS. 1-4 illustrates skirt system 100 according to an example embodiment. Skirt system 100 includes skirt 110 and skirt mounting mechanism 112. As shown by FIG. 2, skirt 110 includes a shoulder 114 configured to rest upon step 42 of guard 30. Skirt 110 further includes a channel 116 receiving and supporting attachment or mounting mechanism 112. Skirt 110 is configured to extend below lower edge 40 by a distance of at least about ½ inch when skirt 110 is mounted to guard 30 by mounting mechanism 112. Skirt 110 has a rigidity so as to flex when manually pressed against an obstruction and so as to substantially maintain it shape when impacted by flying debris propelled by cutting member 28. In one embodiment, skirt 110 is integrally formed as a single unitary body out of one or more polymer materials. As shown in FIG. 3, skirt 110 has an arcuate shape. In one embodiment, skirt 110 has an arcuate shape prior to being mounted to guard 30. In another embodiment, skirt 110 is configured to be manually deformed or bent to an arcuate shape substantially corresponding to guard 30. In one embodiment, skirt 110 is formed from an elastomeric material such as rubber and has a thickness in those portions that extend below edge 40 of about inch.

Mounting mechanism 112 is configured to mount skirt 110 to guard 30. In the embodiment illustrated, mounting mechanism 112 is configured to mount skirt 110 in a removable fashion such a skirt 110 may be separated and removed or replaced without subjecting guard 30 to damage and without the use of tools or removal of fasteners. In the example illustrated, mounting mechanism number 112 comprises two opposing portions of a hook and loop fastening system (VELCRO). According to one embodiment, a person removes protective strips or covers on adhesive sides of both portions of the hook and loop faster system so as to secure a first portion of the hook and loop fastening system to surface 116 of skirt 110 and so as to secure a second portion of the hook and loop faster system to an outer surface of sidewall 32 above step 42. As a result, skirt 110 is releasably held or mounted to guard 30.

As shown by FIG. 3, skirt 110 extends along a substantial entirety of guard 30 in an arc. In other embodiments, skirt 110 may include multiple flat panels angled with respect to one another along guard 30. As shown by FIG. 4, in other embodiments, skirt system 100 may alternatively include skirt 110′ which extends along only a portion of the guard 30.

Overall, guard 30 and skirt 110 form a shield at least partially about hub 26 and cutting member 28 between the cutting member 28 and user at the rear of the grass trimmer (the user holds the grass trimmer generally in front of himself or herself). In one embodiment, the shield extends at least 45 degrees about the hub 26. In one embodiment, the shield extends below a lowest most point of hub 26. In one embodiment, the shield extends at least one inch below the lowest most point of the hub. As a result, flying debris is more effectively blocked. In other embodiments, the overall shield formed by guard 30 and skirt 110, may have other extents.

In the example illustrated, system 100 provides for tool less installation and facilitates molding of skirt 110 provide skirt 110 with aesthetic and functional form factors. In some embodiments, skirt 110 may have a uniform cross-sectional shape such that skirt 110 may be extruded. As shown by FIG. 1, skirt 110 may be provided with rounded corners to facilitate catching of skirt 110 on thick grass when moving laterally. As further shown by FIG. 1, skirt 110 may be provided with integrally molded logos or adhered labeling. In yet other embodiments, guard and skirt may be integrally molded as part of a single unitary body or may be permanently mounted to one another.

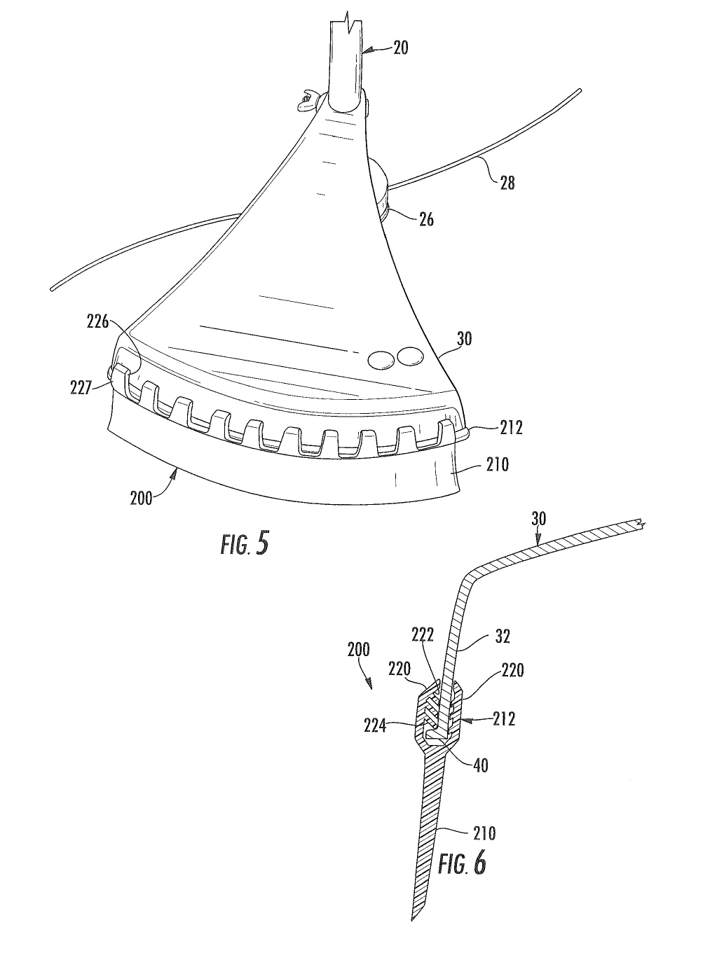

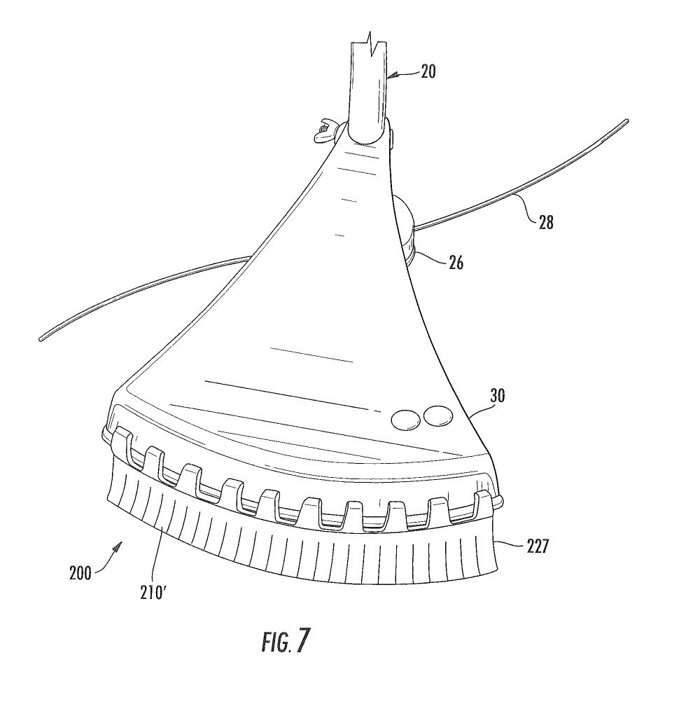

FIGS. 5-8 illustrate skirt system 200. Skirt system 200 includes skirt 210 and mounting mechanism 212. As shown by FIG. 5, skirt 210 extends below edge 40 of guard 30. Mounting mechanism 212 extends from upper perimeter of skirt 210. In the example illustrated, mounting mechanism 212 is integrally formed as a single unitary body with skirt 210. In the example illustrated, mounting mechanism to 12 includes a pair of resiliently flexible walls 220 which form intermediate channel 222 configured to receive edge 40 of sidewall 32 of guard 30. Mounting mechanism 212 additionally includes inwardly projecting resiliently flexible ribs or fingers 224 which project inwardly towards one another and towards guard 30 so as to further flex and grip portions of sidewall 32 to secure skirt 210 to guard 30. As shown by FIG. 5, in one embodiment, mounting mechanism 212 may include multiple spaced slots 226 separating tabs 227, facilitating arcuate deformation of mounting mechanism 212 and skirt 210 to accommodate the art of sidewall 32. As shown by FIG. 7, in some embodiments, skirt system 200 may alternatively include skirt 210′ which is provided with slits 227 which provides skirt 210′ with additional flexibility. In one embodiment, system 200 may be configured such that skirt 210 may be manually cut with a scissors to a desired arc length. In such an embodiment, slots 226 in both of walls 220 facilitate easier cutting of system 200 to a desired length. In yet another embodiment, skirt 210 may include scores or perforations at various locations along skirt 210 which are configured to facilitate cutting, breaking or tearing of skirt 210 to a desired length to match or approximate a length of guard 30

Overall, system 200 facilitates tool less installation. In addition, with the use of a scissors, system 200 may be provided with any of a variety of different lengths to match a variety of different guards 30. System 200 is further inexpensive to manufacture. For example, one embodiment, system 200 may be formed using extrusion followed with a die cut. In one embodiment, skirt 110 may be formed from one or more molded polymers. System 200 has enhanced versatility, being able to fit multiple trimmer guards and being able to be deformed to address compound curvatures of different guards with a one piece solution.

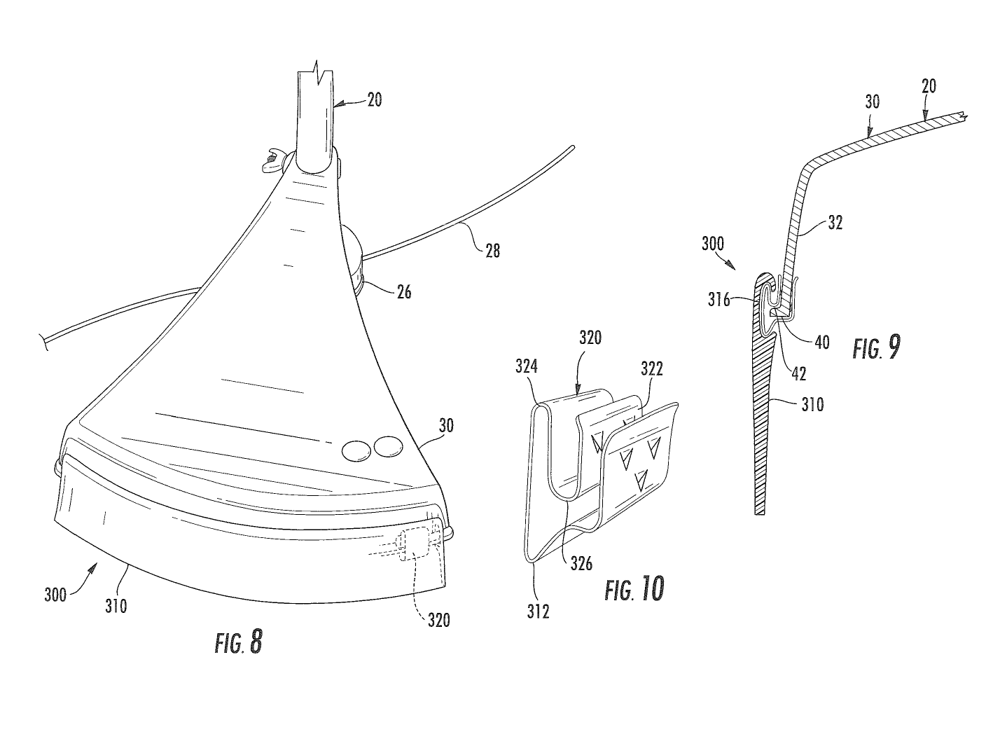

FIGS. 8-10 illustrate skirt system 300. FIG. 8 illustrates skirt system 300 with portions transparently shown for purposes of illustration. System 300 includes skirt 310 and mounting mechanism 312. As shown by FIGS. 9 and 10, skirt 310 includes a C-shaped channel 316. Mounting mechanism 312 comprises a clip 320 having a channel 322 configured to receive edge 40 of a sidewall 32 of guard 30 and an outer portion 324 shaped to be received within channel 316. Clip 32 is further provided with a shoulder 326 configured to rest upon step 42 of sidewall 32. As a result, clip 320 may be securely mounted to a lower end of sidewall 32 of guard 30.

Although channel 316 and portion 324 are illustrated as having depicted corresponding mating male and female shapes, in other embodiments, channel 316 and portion 324 may have other shapes and may be configured so as to not necessarily mate. In the particular example illustrated, portion 324 serves as a tongue while channel 316 serves as a groove. In other embodiments, clip 320 may be provided with a groove while skirt 310 includes a corresponding tongue for securing skirt 310 to clip 320 and ultimately to guard 30.

Overall, system 300 provides a secure semi-permanent mounting mechanism for skirt 310. Skirt 310 may be configured to fit substantially all trimmer guard lengths. In addition, system 300 is an expensive to manufacture, comprising an extruded skirt 310 and clips 320 which may comprise spring-steel clips. Clip 320 facilitates removal and replacement of skirt 310 without replacement of clips 320. As a result, when skirt 310 becomes worn, skirt 310 may be easily and quickly replaced.

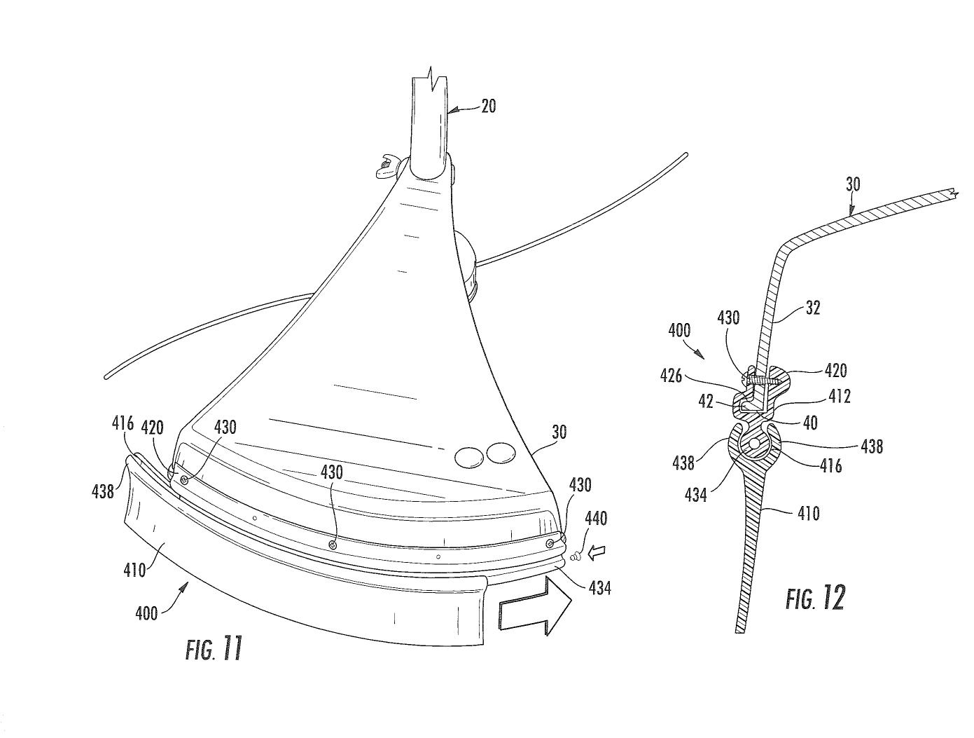

FIGS. 11-12 illustrate skirt system 400. System 400 includes skirt 410 and mounting mechanism 412. Skirt 410 is a polymeric molded member having end integrally formed C.-shaped groove or channel 416 along its upper edge.

Mounting mechanism 412 comprises a clip or structure 420 configured to be mounted to guard 30 proximate edge 40 of sidewall 32. In the particular example illustrated, structure 420 includes a shoulder 426 configured to air against the rest upon step 42 of sidewall 32, enhancing securement and retention of structure 420 to guard 30. As further shown by FIG. 12, mounting mechanism number 412 may optionally be provided with fasteners 430 which extend through or at least partially penetrate sidewall 32.

As further shown by FIG. 12, structure 420 includes a downwardly projecting tongue 434 configured to be received within groove 416, facilitating removable securement of skirt 410 to mounting mechanism 412 and to guard 30. In one embodiment, skirt 410 includes opposing walls before 38 which form groove 416. Walls 438 are resiliently flexible, permitting tongue 434 to be inserted in a direction perpendicular to an axial centerline of the channel 416. In another embodiment, such sidewalls 438 are sufficiently rigid and inflexible such that skirt 410 may only be removed from or mounted to structure 420 by sliding tongue 434 through and along channel 416 along the axial centerline of channel 416. In such an embodiment, as shown by FIG. 11, system 400 may additionally include a cap or fastener 444 actually securing skirt 410 upon structure 420. In one embodiment, fastener 444 may comprise a threaded screw configured to be tapped or screwed into channel 416 to axially retain skirt 410 on structure 420. In other embodiments, other mechanism may be used to retain skirt 410 upon structure 420.

Although groove 416 and tongue 434 are illustrated as having circumferential cross-sectional shapes, in other embodiments, they may have other shapes such as a T-shaped groove and a T-shaped cross-sectional tongue. Although skirt 410 is illustrated as having groove 416 while structure 420 is illustrated as having tongue 434, in other embodiments, this relationship may be reversed. Although structure 420 is illustrated as being secured to guard 30 by fasteners 430 and as a result of its shape, structure 420 may be secured to guard 30 in other fashions such as with adhesive, VELCRO or other mounting structures. Structure 420 may also have other configurations not necessarily matching the lower end of guard 30.

Overall, system 400 provides a structurally sound skirt attachment system. System 400 provides a two-piece system which isolates a compound curvature of guard 30 from skirt 410 which may be extruded. As with system 300, system 400 enables easy removal and replacement of skirt 410.

FIGS. 13-29 illustrate alternative skirt systems 500, 600, 700, 800 and 900. As with systems 100-400 described above, systems 500-900 provide skirts which may be easily added to an existing guard 30 and may accommodate a wide variety of grass tremors. Such systems are durable so as to withstand being hit by the trimmer string 28 and stones or gravel which may become propelled. The systems are also not too obtrusive and do not substantially interfere with trimming tasks. However, at the same time, such systems provide enhanced protection against thrown grass, rocks and debris.

FIGS. 13-15 illustrate skirt system 500. Skirt system 500 is similar to skirt system 100 expect that skirt system 500 includes skirt 510 and skirt mounting mechanism 512. As shown by FIG. 15, skirt mounting system 512 includes fasteners provide 14 extend through skirt 510 into guard 30. In the example illustrated, skirt 510 includes precut holes 516 through which fasteners 514 extend. Holes 516 are spaced along a length of skirt 510, allowing skirt 510 to be mounted to different trimmers having different sized guards 30. In one embodiment, fasteners 514 comprise self-tapping screws.

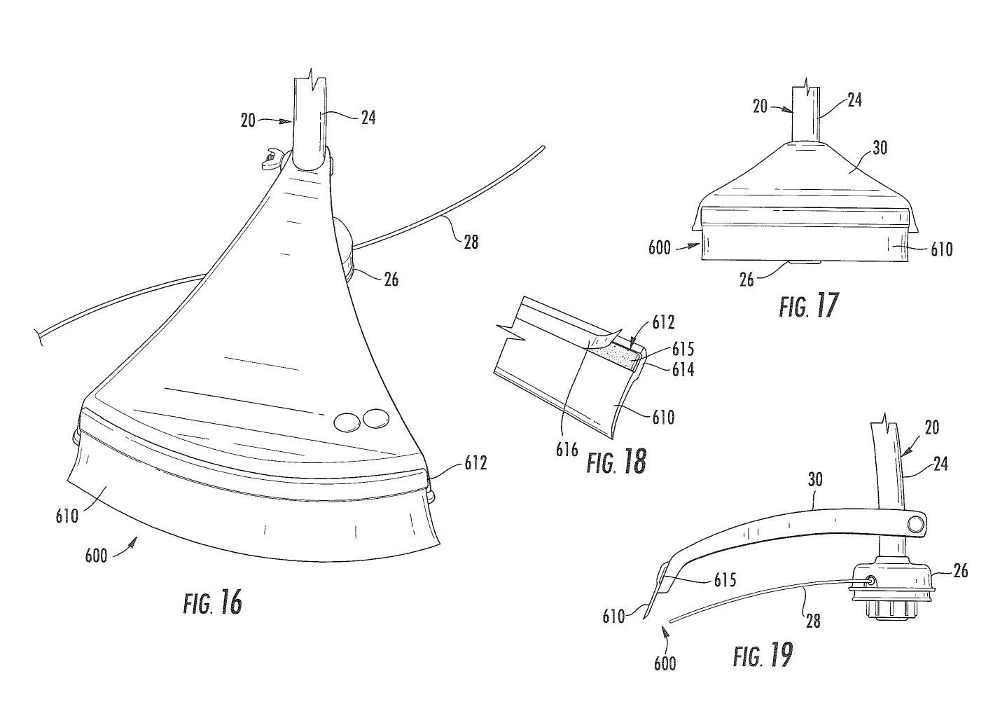

FIGS. 16-19 illustrate skirt system 600. Skirt system 600 is similar to skirt system 100 except that skirt system 600 includes skirt 610 and skirt mounting mechanism 612. Skirt 610 is similar to skirt 110 except that skirt 610 includes a channel 614. Adhesive mounting mechanism 612 comprises a strip of adhesive tape, paste or other bonding material 615 within channel 614 and temporarily covered with a peel away tape 616. As shown by FIG. 23, the peel away tape 616 may be removed, exposing a sticky or tacky surface of material 615. Thereafter, a shown by FIGS. 16 and 19, the exposed surface of material 615 is positioned into contact with guard 30 to it easily bond skirt 6 110 to guard 30. In some embodiments, channel 614 may be omitted.

FIGS. 20-22 illustrates skirt system 700. Skirt system 700 includes skirt 710 and mounting mechanism 712. As shown by FIGS. 25 and 26, mounting mechanism 712 includes a pair of C-clamps 714 located at opposite ends of skirt 710 and configured to wrap around both skirt 710 and guard 30 such that skirt 710 and guard 30 are sandwiched between opposite sides of clamps 714. In the example illustrated, mounting mechanism 712 additionally includes fasteners 716, comprising bolts, screws or the like, which extend through one side of clamps 716 through skirt 710 and into contact with an exterior surface of guard 30 as shown in FIG. 22. Fasteners 716 create tension to secure skirt 710 on guard 30. In other embodiments, fasteners 716 may have other configurations or may be omitted.

FIGS. 23-26 illustrate skirt system 800. Skirt system 800 is similar to skirt system 200 shown in FIGS. 5 and 6 except that skirt system 800 includes skirt 810. Skirt 810 is similar to skirt 210 (shown in FIG. 5) except that skirt 810 omits slots 226 and tabs 227. Skirt 810 wraps about opposite sides of guard 30. The remaining elements of skirt system 810 which correspond to elements of skirt system 200 are numbered similarly.

FIGS. 27-29 illustrate skirt system 900. Skirt system 900 is similar to skirt system 600 except that skirt system 900 includes skirt 910 and mounting mechanism 912. Skirt 910 is similar to skirt 610 except that skirt 910 is additionally configured to extend over and above a top surface of guard 30 so as to extend across a horizontal portion of guard 30. In one embodiment, skirt nine and 10 includes a centralized central portion 915, providing skirt 910 which increased or enhanced rigidity. In one embodiment, portion 915 of skirt 910 includes a closed-cell foam structure. In other embodiments, centralized portion 915 may be provided with ribs or other rigidifying configurations or geometries.

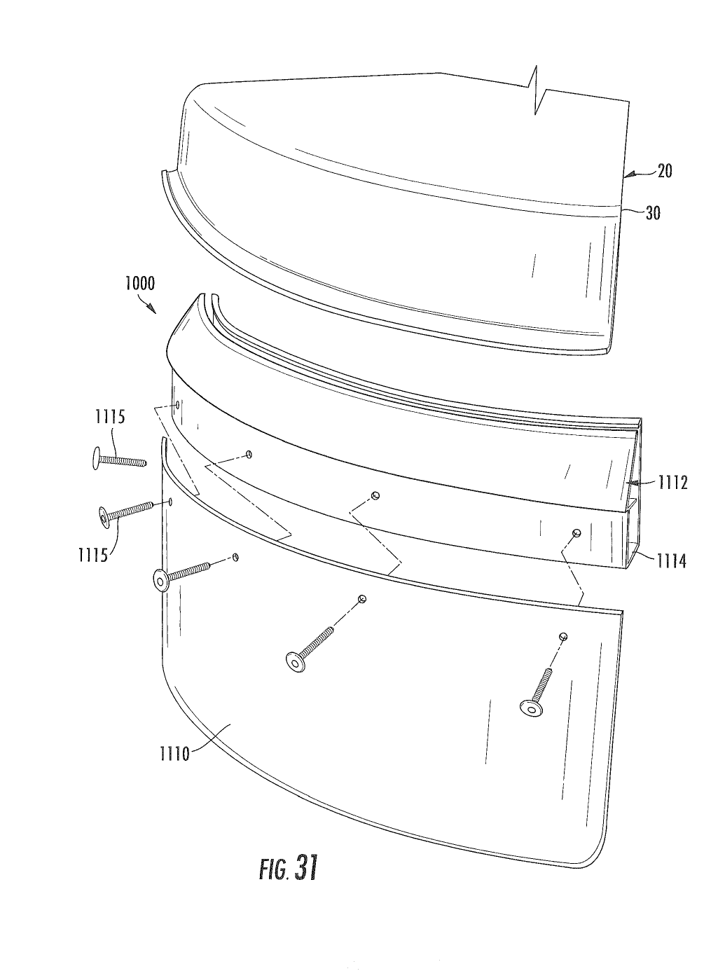

Mounting mechanism 912 is similar to mounting mechanism 612. Mounting mechanism 912 includes adhesive materials 915, such as strips of tape, paste or other tacky or adhesive material, dispose within channels 914 and configured to secure and retain skirt 910 to guard 30. As shown by FIG. 29, channels 914 and adhesive materials 915 are located along both be substantially vertical portion 920 of skirt 910 and along the substantially horizontal portion 922 of skirt 910. Because adhesive materials 915 are located along both the vertical portion 920 and horizontal portion 922 of guard 30, mounting mechanism 912 or securely retains skirt 910 to guard 30. In other embodiments, adhesive materials 915 are provided at additional or alternative locations along the skirt 910. In still other embodiments, adhesive materials 915 may alternatively be replaced with other releasable or permanent mounting mechanisms such as hook and loop fastening systems like those shown in FIG. 2.

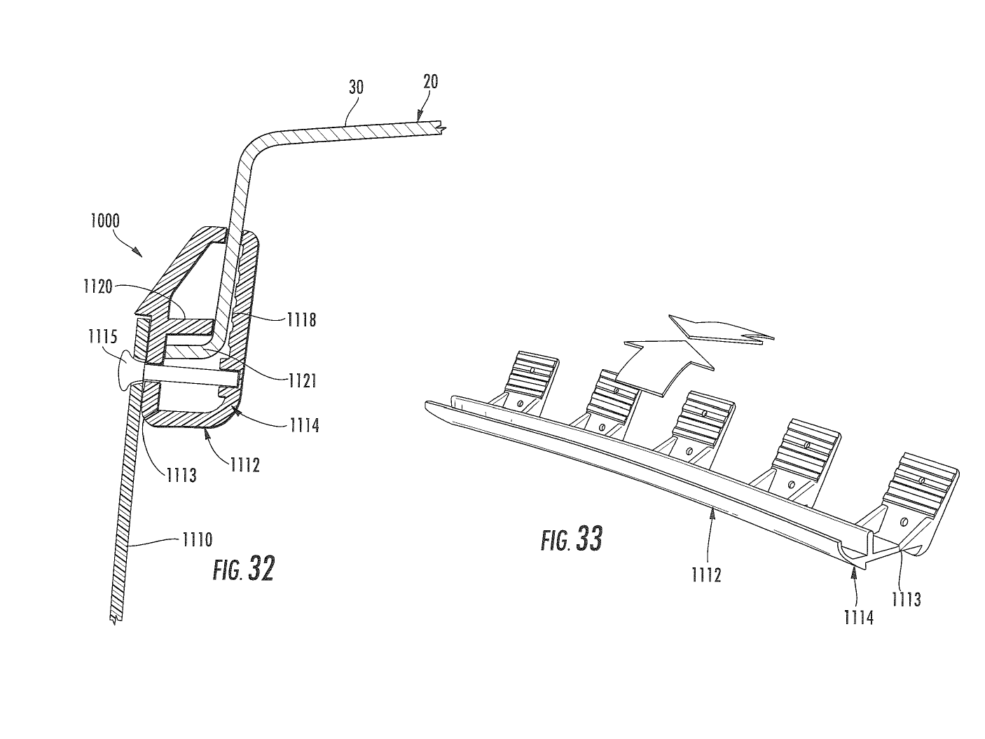

FIGS. 30-33 illustrate skirt system 1000, another embodiment of skirt system 100. Skirt system 1000 includes skirt 1110 and mounting mechanism 1112 as shown by FIGS. 32 and 33, mounting mechanism 1112 comprises a molded flexible polymeric mounting bracket 1114 and fasteners 1115. Bracket 1114 includes serrations, teeth, dimples or other structures 1118 providing a high friction surface configured to grip a backside of guard 30. Bracket 1114 further includes a strut, projection or catch 1120 configured to extend over a lower lip 1121 of guard 30. As a result, bracket 1114 grips and is retained against opposite sides of guard 30. In the particular example illustrated, bracket 1114 has a clam shell configuration and pivots about guard 30. In the particular example illustrated, bracket 1114 is integrally formed as a single unitary body and includes a living hinge 1113 (a thin more flexible area in the integral structure along which portions may bend, flex or pivot). In other embodiments, other mechanical hinge arrangements may be employed. Bracket 1114 folds about a lower end of guard 30 to capture an end of guard 30. Fasteners 1115 pass through openings within skirt 1110 and bracket 1114 to secure skirt 1110 to bracket 1114 and to further retain bracket 1114 in a clamped configuration about guard 30. As a result, mounting mechanism 1112 does not require perforation of guard 30 to mount skirt 1110 to guard 30.

Although the present disclosure has been described with reference to example embodiments, workers skilled in the art will recognize that changes may be made in form and detail without departing from the spirit and scope of the defined subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

1. An apparatus comprising:
a skirt configured to be mounted to a guard of a grass trimmer.

2. The apparatus of claim 1, wherein the skirt includes a compressible adhesive pad configured to adhere the skirt to the guard.

3. The apparatus of claim 1, wherein the guard includes a step and wherein the skirt includes a shoulder configured to rest upon the step.

4. The apparatus of claim 1 further comprising one of a hook and loop fastener portion configured to be mounted onto the card and the other of the hook and loop fastener portion mounted on the skirt.

5. The apparatus of claim 1, wherein the skirt includes opposing walls forming a cavity therebetween that is configured to receive an edge of the guard.

6. The apparatus of claim 5, wherein the cavity is configured to receive a lower edge of the guard.

7. The apparatus of claim 5, wherein the cavity is configured to receive a side edge of the guard.

8. The apparatus of claim 5 further comprising a threaded fastener extending through one of the walls and configured to press the guard against the other of the opposing walls.

9. The apparatus of claim 5, wherein at least one of the opposing walls includes slits.

10. The apparatus of claim 5, wherein at least one of the opposing walls includes ribs configured project into engagement with the guard.

11. The apparatus of claim 10, wherein the ribs are resiliently flexible.

12. The apparatus of claim 1, wherein the skirt is sufficiently flexible so as to be manually deformed to arcuate shape a substantially corresponding to an arcuate shape of the guard.

13. The apparatus of claim 1, wherein the skirt is configured to be manually cut with a scissors to a desired length.

14. The apparatus of claim 1, further comprising a clip configured to be mounted to the guard, wherein the skirt is removably mounted to the clip.

15. The apparatus of claim 14, wherein the clip includes a channel configured to receive an edge of the guard.

16. The apparatus of claim 13, wherein the clip includes a one of a tongue and a groove, wherein the skirt includes the other about a tongue end a groove and wherein the groove receives a tongue to mount the skirt to the clip.

17. The apparatus of claim 16, wherein the tongue and groove are configured to extend along a side of the guard.

18. The apparatus of claim 16, wherein the tongue and groove are configured to extend the low end edge of the guard.

19. The apparatus of claim 16 further comprising a cap configured to plug an end of the groove.

20. The apparatus of claim 14, wherein the clip includes a fastener configured to penetrate at least partially through the guard to mount the clip to the guard.

21. The apparatus of claim 1 further comprising fasteners coupled to the skirt and configured to at least partially penetrate the guard.

22. The apparatus of claim 1, wherein the guard includes a side wall and a top and wherein the skirt includes a side portion configured to extend opposite at least a portion of the side wall and a cover portion configured to extend opposite at least a portion of the top.

23. The apparatus of claim 22 further comprising an adhesive on the cover portion.

24. The apparatus of claim 22 further comprising an adhesive on the side portion.

25. The apparatus of claim 22, wherein the side portion is curved.

26. The apparatus of claim 1, wherein the skirt has a mounting portion configured to be mounted adjacent the guard and an exterior portion configured to extend at least 0.5 inches below a lower edge of the guard.

27. The apparatus of claim 26, wherein the exterior portion is resiliently flexible.

28. The apparatus of claim 1, wherein the skirt has a rigidity so as to flex when manually pressed against an obstruction and so as to substantially maintaining shape when impacted by flying debris propelled by the trimmer.

29. The apparatus of claim 1, wherein the skirt is configured to project from the guard at a draft corresponding to a draft of the guard.

30. The apparatus of claim 1, wherein the skirt has an arcuate length less than an arcuate length of the guard.

31. The apparatus of claim 1, wherein the skirt has an arcuate length of at least about 7 inches.

32. The apparatus of claim 1, wherein the skirt is formed from one or more polymers.

33. A grass trimmer comprising:
a shaft;
a hub at an end of the shaft;
a cutting member extending from the hub and configured to be rotationally driven about the hub; and
a shield extending about the hub and about the cutting member, wherein the shield extends below a lowest most point of the hub.

34. The grass trimmer of claim 33, wherein the shield extends at least one inch below the lowest most point of the hub.

35. The grass trimmer of claim 33, wherein the shield comprises:
a guard extending about the hub; and
a skirt extending from the guard below the lowest most point of the hub.

36. The grass trimmer of claim 33, wherein the skirt is mounted to the guard.

37. The grass trimmer of claim 33, wherein the skirt is removable from the guard without damage to the guard or the skirt.
